(19) United States
(12) Patent Application Publication
(10) Pub. No.: US 2018/0130079 A1
(43) Pub. Date: May 10, 2018

(54) METHOD AND APPARATUS FOR DETERMINING THE EFFECTIVENESS OF PERFORMANCE INCENTIVES

(71) Applicant: Center On Executive Compensation, Washington, DC (US)

(72) Inventor: Michele A Carlin, Bakersfield, CA (US)

(21) Appl. No.: 15/698,110

(22) Filed: Sep. 7, 2017

Related U.S. Application Data
(60) Provisional application No. 62/415,635, filed on Nov. 1, 2016.

(51) Int. Cl. G06Q 30/02; G06Q 10/06; H04L 29/06

(52) U.S. Cl. CPC G06Q 30/0211; H04L 63/10; H04L 63/08; G06Q 10/06393

(57) ABSTRACT

A method and apparatus for analyzing performance metrics and displaying a customized set of resulting parameters based on the analysis. The apparatus includes a central processing unit, memory, a user input unit and an associated display device. Predetermined stored sets of historic performance analytic data is analyzed against current performance data and the results are displayed on the display device.

### CROSS-REFERENCE TO RELATED APPLICATION

The present application claims priority to provisional patent application Ser. No. 62/415,635 filed Nov. 1, 2016 and entitled “Method And Apparatus For Determining The Effectiveness Of Performance Incentives.”

### TECHNICAL FIELD

The present invention generally relates to the field of tracking and monitoring business processes, and more particularly, is directed to a method and apparatus for analyzing performance metrics and displaying a customized set of resulting parameters based on the analysis.

### BACKGROUND

Companies utilize many performance management techniques for motivating employees to increase profitability and ownership value. It is now commonplace for companies to use incentive plans as a reward system to improve employee performance. Under such plans, a financial award often is tied to a company metric, such as company share price, increase in sales or profitability. More generally, business metrics are information that represents important business processes that managers track and monitor to assess the state and success of their business.

There are several types of incentive plans that are known in the art, from simple to complex. Annual incentives tend to represent corporate performance and are typically tied to one or more financial and business metrics, while long-term incentive plans, which are often the largest element of executive pay, measure financial and business achievement over a longer period, typically over three or more years.

Some incentive plans allow employees to purchase company stock at a discount. However, the most prevalent forms base the earned amount on the individual, group or company's performance against a specified metric and standard.

Incentive plans are popular components of executive pay. The purpose of these incentives is to reward the executive for achieving company objectives that maximize shareholder value.

While most incentive plans are designed to increase shareholder value by motivating employees to perform at a higher level, plans that directly relate to executive pay are often the most important in this regard. This is so because executive decisions and actions usually have the greatest impact on company success. Thus, such incentive plans must be carefully structured to insure alignment with shareholder interest, superior executive performance and cost effectiveness.

Boards of Directors are charged with providing oversight of the executive pay programs of companies, including the selection of performance metrics in incentive plans. The process has become more important as the result of the Dodd-Frank Wall Street Reform and Consumer Protection Act (Pub.L. 111-203), which required the development of rules that mandate shareholders be given the right to cast an advisory vote on executive compensation, which occurs annually for most companies.

As a consequence of these so called “Say on Pay” rules, shareholders and other stakeholders are placing increased focus on executive performance. They are beginning to question the choice of performance measures and business metrics upon which executive pay is based—and whether the performance targets that must be attained are rigorous enough to justify the pay levels earned when those targets are met.

Every area of business has specific performance metrics that are important to monitor on an ongoing basis.

For example, a marketing department might track marketing metrics such as the total number of visits to a website, number of new visitors and most popular pages. A sales department might track the number of conversions on the website and payment methods. Senior executives might track big picture metrics like financial information.

As stakeholders respond to this increasing focus on the measures of performance, management teams and board compensation committees lack ready and easy access to the information that would help them ensure that the metrics they are using to reward executives are truly those that are linked to the creation of shareholder value over time. Even in a world of ever-increasing access to data and more cost effective means to analyze that data, practitioners lack effective tools to support a fact-based decision-making approach to determining the metrics used to measure executive performance.

While the prior art is aware of a number of methods of collecting business metrics, none provide a method and apparatus for analyzing the performance metrics used to measure the performance of corporate executives and displaying a customized set of resulting parameters based on the analysis.

### BRIEF DESCRIPTION OF THE DRAWINGS

The novel features of the present invention are set out with particularity in the appended claims, but the invention will be understood more fully and clearly from the following detailed description of the invention as set forth in the accompanying drawings in which:

FIG. 1 is a flow chart illustrating the overall operation of the method and apparatus of the present invention;

FIG. 2 is a flow chart illustrating the core function of metric correlation analysis in accordance with the present invention;

FIG. 3 is a flow chart illustrating the core function of incentive plan effective analysis with a focus on prevalence analysis in accordance with the present invention;

FIG. 4 is a flow chart illustrating the core function of incentive plan effective analysis in accordance with the present invention;

FIG. 5 is a flow chart illustrating the core function of incentive target setting analysis;

FIG. 6 is a block diagram illustrating the various databases that are used to implement the present invention; and

FIG. 7 is a block diagram of a computer system which may be used to implement the exchange in accordance with the present invention.

### DESCRIPTION OF THE PREFERRED EMBODIMENT

While the present invention is described in the context of performance metrics used to measure the performance of corporate executives, it may also be used to measure the performance of others managers and leaders.

The method and apparatus of the present invention allows companies to answer several critical questions related to the use of financial performance measures in incentive plans, such as:
What financial metrics are commonly used in the incentive plan designs of peer companies?
How does that change as our peer group changes?
Are the financial metrics used in our incentive plans correlated to long-term shareholder value in our industry, and if so, over what time periods?
Are there other financial measures that are more highly correlated to shareholder value in our industry?
What incentive plan metrics are correlated to higher company performance?
How can we use historical data to establish appropriate target levels of performance for our incentive plans?

The present invention provides incentive plan designers, management teams, boards and investors with access to data that will inform the selection and evaluation of the financial performance measures used to determine executive pay. It will introduce a level of rigor and analysis to the design process that will help all stakeholders ensure that a company's pay for performance philosophy is reflected in the actual design of its pay programs. Stated simply, it will help management, boards and investors make sure that not only is pay aligned with performance, but that companies are rewarding the right performance.

By combining financial data with proxy data, the present invention will benefit a range of users who are involved in designing, approving and evaluating incentive plans—professionals in human resources and finance, compensation consultants, Board Compensation Committees, and investors.

The Exchange is envisioned as a stand-alone service, accessible to users through an online portal and through mobile applications. The Exchange will interface with external systems to import two basic types of data—company-specific and market index (e.g. S&P 500) financial data, and company-specific data describing the use of specific financial performance measures in executive incentive plans.

Users will be able to view the output of the Exchange's analysis on computer and mobile device screens; will be able to print the analysis and output; and will be able to download reports in both Excel and pdf format. Output from the Exchange (charts, graphs, statistical analysis) will not be exported to other systems.

There are four potential user groups for the Exchange:
members of management charged with incentive plan design and implementation;
members of Boards of Directors responsible for oversight and approval of executive pay;
compensation consultants providing services to management and/or

Boards of Directors and Compensation Committees; and
investors.

The primary user of The Exchange will be a member of management engaged in the design, development and approval of executive incentive plan. This will include professionals in human resources and finance organizations—each of whom will possess very different characteristics.

Users in the HR profession will be the primary target users of the Exchange. These professionals likely will be those specializing in compensation or executive compensation. They will have a basic working knowledge of financial measures and statistical analysis. However, most are not likely to have a highly developed understanding of finance, financial analysis or business value driver analysis. Because of this, the Exchange will need to be easy to navigate and provide (where possible) online access to data definitions, interpretive explanations, etc.

In many organizations, the selection of incentive plan metrics is the responsibility of the Finance organization. Because finance teams are expected to be an important user group, accuracy and precision of the metrics used will be important to the development of the Exchange. Therefore, input from individuals with deep financial expertise will be critical.

Boards and Compensation Committees will find the Exchange a useful tool to independently evaluate the metrics recommended by management for inclusion in executive incentive plans. This group will value simplicity (especially in the user interface) in order to make sure the tool is relevant and accessible.

In order to support their management and Board clients, some compensation consultants will use the Exchange. At a minimum, most will need to develop an understanding of the Exchange's functionality, output and reports.

Investors will increasingly be a driving force behind the need for rigor and analysis in the selection of incentive metrics. As such, they may find the Exchange a useful tool to supplement their existing tools. Similar to the Finance professional, the Exchange will need a high level of accuracy and precision in the selection of financial metrics, the development of a data dictionary and the design of the correlation analyses.

The high-level functional requirements of the Exchange are organized based on the system's core functions as follows:
Metric Correlation Analysis (MCA);
Incentive Plan Effectiveness (IPE); and
Incentive Target Setting (ITS).

In addition, basic administrative functional requirements are included (ADM). Within each function, specific functionality is defined. Requirements are assigned a priority level of:

1. Must Have;

2. Significantly Improves Functionality; or

3. Future Enhancement.

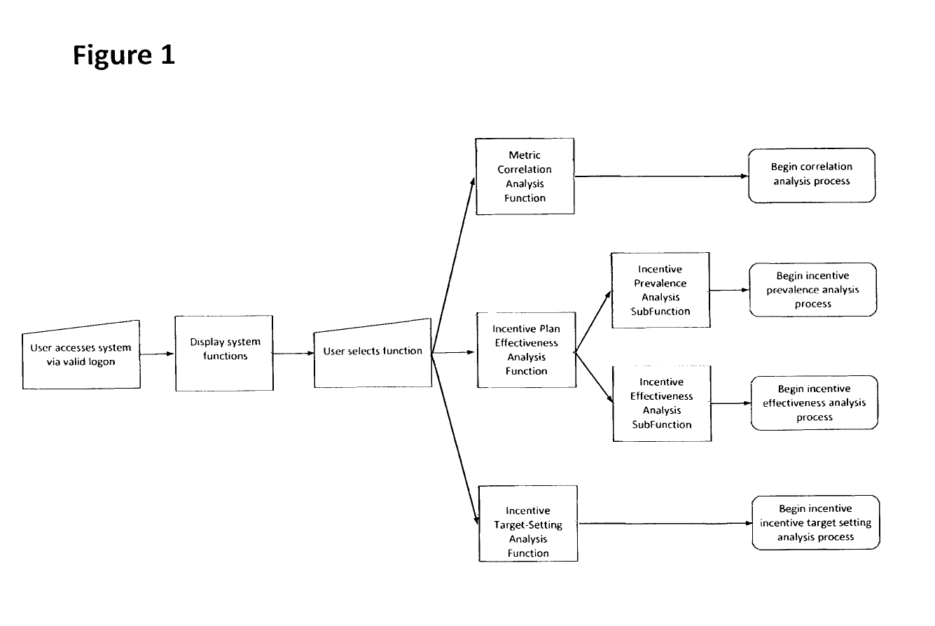

FIG. 1 is a flow chart illustrating the overall operation of the exchange in accordance with the present invention.

A brief description of the Core Functions is presented below, followed by the specific high level requirements within each function.

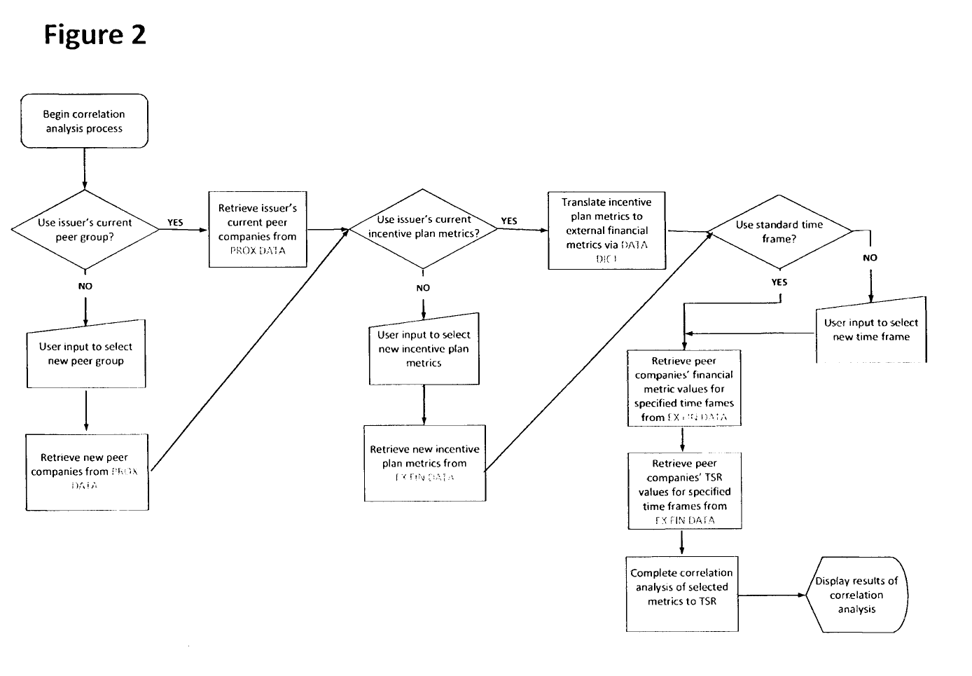

### Core Function: Metric Correlation Analysis—FIG. 2

The Metric Correlation Analysis function is intended to help users determine the statistical relationship of specific financial metrics to a measure of shareholder value (initially, Total Shareholder Return) for a specified peer group over a specified time horizon. Practitioners and compensation consultants will use this functionality to assess the appropriateness of including various financial metrics in their incentive plans. Investors can use this functionality to assess the appropriateness of specific financial measures for a specific issuer, peer group or industry sector. This functionality helps provide insight to the question, “Do the metrics we're using in our incentive plans support the creation of long term shareholder value?”

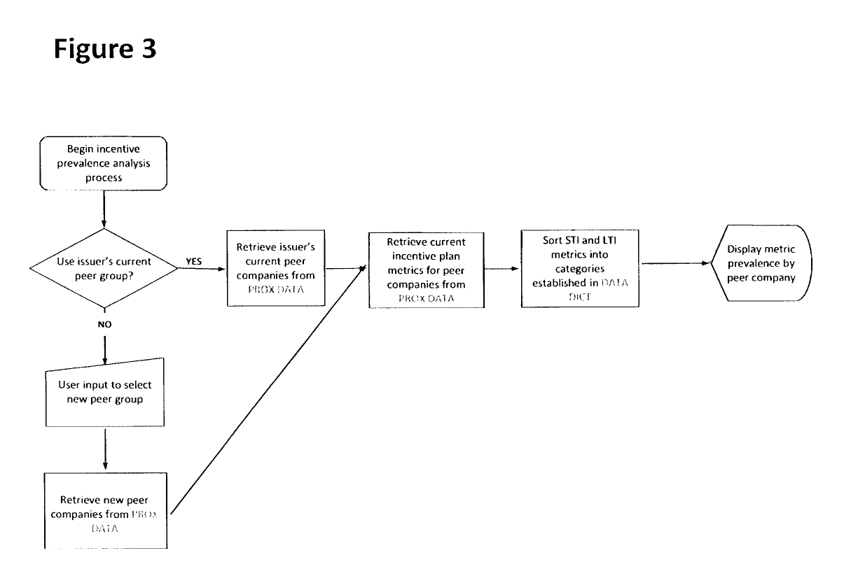

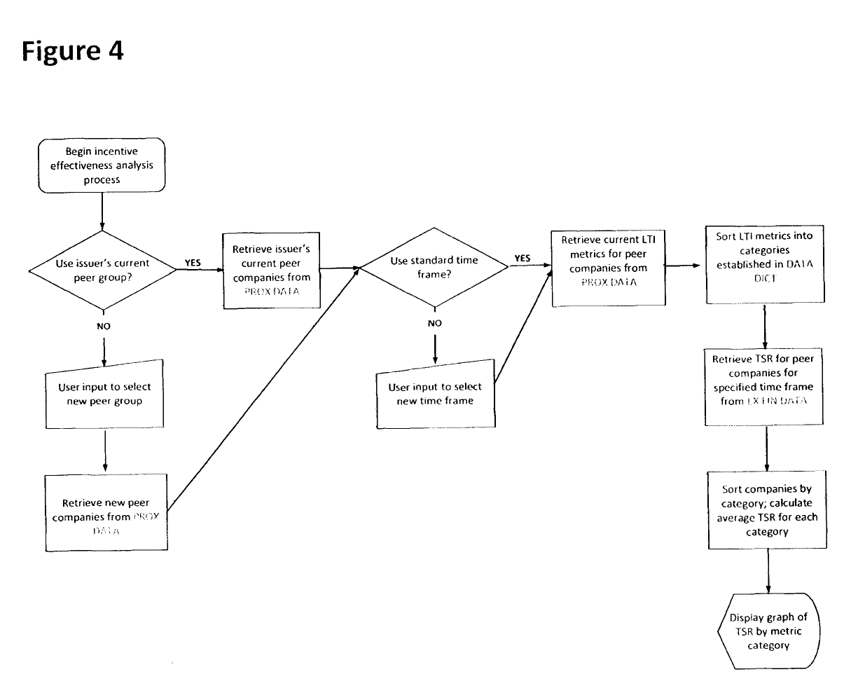

### Core Function: Incentive Plan Effectiveness—FIGS. 3 and 4

The Incentive Plan Effectiveness function is intended to help users determine how the presence of a specific metric in a company's long term incentive plan is related to the company's value-creation performance (as measured by TSR), compared to other companies in their peer group. Stated differently, this functionality will test whether companies using a specific metric in their LTI plans perform better on TSR than companies using other metrics. This functionality will help issuers and investors assess the alignment of a company's long term incentive plan to value creation.

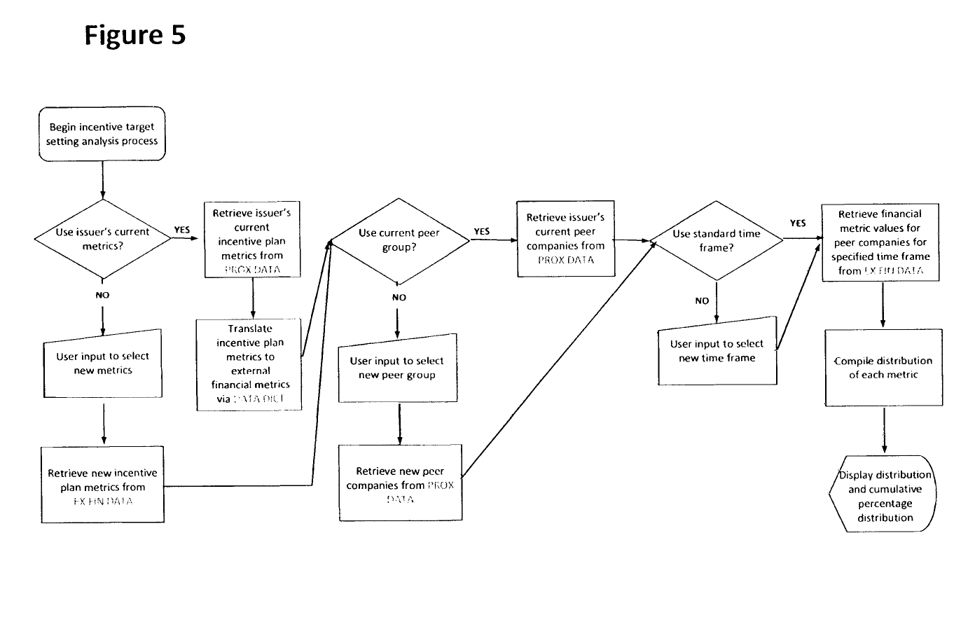

### Core Function: Incentive Target Setting—FIG. 5

The Incentive Target Setting function is intended to help users establish target performance levels for their incentive plans by using an analysis of historical data to build a distribution of the probability of various performance outcomes. This functionality will show how a selected group of companies' performance on a specific metric over user-defined time periods. By conducting this analysis, users will have a fact-based foundation upon which to establish threshold, target and maximum performance levels in their incentive plans.

The specific functionality for each function is described in the table below.

| Core | | | | |
|---|---|---|---|---|
| Function | Req # | Requirement Description | Comments | Priority |
| ADM | ADM-1 | The system will display | | 1 |
| | | user's name and affiliation | | |
| ADM | ADM-2a | For users who are issuers, | | 1 |
| | | the system will display the | | |
| | | following: | | |
| | | Current stock price | | |
| | | of the issuer | | |
| | | Financial metrics | | |
| | | used in the issuer's | | |
| | | most recently | | |
| | | disclosed short term | | |
| | | incentive (STI) plan | | |
| | | Financial metrics | | |
| | | used in the issuer's | | |
| | | most recently | | |
| | | disclosed long term | | |
| | | incentive (LTI) plan | | |
| | | The companies in | | |
| | | the issuer's most | | |
| | | recently disclosed | | |
| | | peer group | | |
| ADM | ADM-2b | For users who are not | | 1 |
| | | issuers, the system will | | |
| | | allow the user to select an | | |
| | | issuer to be analyzed | | |
| MCA | MCA-1 | Using the issuer's current | A detailed | 1 |
| | | peer group, the system will | technical | |
| | | calculate and display in | description | |
| | | graphical format correlation | of the | |
| | | statistics showing the | calculations, | |
| | | relationship of the financial | and a | |
| | | metrics used by the issuer in | specific | |
| | | its STI plan to TSR over 3 | data | |
| | | and 5 years. If the issuer | dictionary, | |
| | | does not use financial | will be | |
| | | metrics in its STI plan, the | developed. | |
| | | system will display a | | |
| | | message indicating the | | |
| | | absence of metrics. | | |
| MCA | MCA-2 | Using the issuer's current | | 1 |
| | | peer group, the system will | | |
| | | calculate and display in | | |
| | | graphical format correlation | | |
| | | statistics showing the | | |
| | | relationship of the financial | | |
| | | metrics used by the issuer in | | |
| | | its LTI plan to TSR over 5 | | |
| | | and 7 years. If the issuer | | |
| | | does not use financial | | |
| | | metrics in its LTI plan, the | | |
| | | system will display a | | |
| | | message indicating the | | |
| | | absence of metrics | | |
| MCA | MCA-3 | Using a user-constructed | | 1 |
| | | peer group, the system will | | |
| | | calculate and display in | | |
| | | graphical format correlation | | |
| | | statistics showing the | | |
| | | relationship of the financial | | |
| | | metrics used by the issuer in | | |
| | | its STI plan to TSR over 3 | | |
| | | and 5 years. If the issuer | | |
| | | does not use financial | | |
| | | metrics in its STI plan, the | | |
| | | system will display a | | |
| | | message indicating the | | |
| | | absence of metrics | | |
| MCA | MCA-4 | Using a user-constructed | | 1 |
| | | peer group, the system will | | |
| | | calculate and display in | | |
| | | graphical format correlation | | |
| | | statistics showing the | | |
| | | relationship of the financial | | |
| | | metrics used by the issuer in | | |
| | | its LTI plan to TSR over 5 | | |
| | | and 7 years. If the issuer | | |
| | | does not use financial | | |
| | | metrics in its LTI plan, the | | |
| | | system will display a | | |
| | | message indicating the | | |
| | | absence of metrics | | |
| MCA | MCA-5 | The system will calculate | | 1 |
| | | and display in graphical | | |
| | | format a correlation analysis | | |
| | | of metrics selected by the | | |
| | | user (from the financial data | | |
| | | dictionary) to TSR of the | | |
| | | issuer's peer group over 3, 5 | | |
| | | and 7 years. | | |
| MCA | MCA-6 | The system will calculate | | 1 |
| | | and display in graphical | | |
| | | format a correlation analysis | | |
| | | of metrics selected by the | | |
| | | user (from the financial data | | |
| | | dictionary) to TSR of an | | |
| | | existing market index (such | | |
| | | as the S&P 500) over | | |
| | | 3, 5 and 7 years. | | |
| MCA | MCA-7 | Using the issuer's peer | | 1 |
| | | group, the system will | | |
| | | calculate and display in | | |
| | | graphical format the | | |
| | | correlation of the financial | | |
| | | metrics used in the issuer's | | |
| | | STI plan to TSR over time | | |
| | | horizons defined by the | | |
| | | user, to be no less than 1 | | |
| | | year and no more than 10 | | |
| | | years. | | |
| MCA | MCA-8 | Using the issuer's peer | | 1 |
| | | group, the system will | | |
| | | calculate and display in | | |
| | | graphical format the | | |
| | | correlation of the financial | | |
| | | metrics used in the issuer's | | |
| | | LTI plan to TSR over time | | |
| | | horizons defined by the | | |
| | | user, to be no less than 1 | | |
| | | year and no more than 10 | | |
| | | years. | | |
| MCA | MCA-9 | The system will calculate | | 1 |
| | | and display in graphical | | |
| | | format a correlation analysis | | |
| | | of metrics selected by the | | |
| | | user (from the financial data | | |
| | | dictionary) to TSR of a | | |
| | | user-selected peer group | | |
| | | over 3, 5 and 7 years. | | |
| MCA | MCA-10 | The system will calculate | | 1 |
| | | and display in graphical | | |
| | | format a correlation analysis | | |
| | | of metrics selected by the | | |
| | | user (from the financial data | | |
| | | dictionary) to TSR of a | | |
| | | user-selected peer group | | |
| | | over 3, 5 and 7 years. | | |
| IPE | IPE-1 | The system will assign each | | 1 |
| | | issuer's financial metrics to | | |
| | | one of eight metric groups. | | |
| | | The specific groups will: | | |
| | | Revenue, Operating | | |
| | | Income, Return on Capital, | | |
| | | Cash Flow, Earnings per | | |
| | | Share, Stock Price, Non- | | |
| | | financial: Operating and | | |
| | | Non-Financial: Governance. | | |
| IPE | IPE-2 | The system will assemble in | | 1 |
| | | chart format the prevalence | | |
| | | of metrics using the defined | | |
| | | metric groups for each | | |
| | | member of the issuer's peer | | |
| | | group. | | |
| IPE | IPE-3 | The system will assemble in | | 1 |
| | | chart format the prevalence | | |
| | | of metrics using the defined | | |
| | | metric groups for a user- | | |
| | | constructed peer group. | | |
| IPE | IPE-4 | The system will calculate | | |
| | | and display in bar chart | | |
| | | form the three-year TSR for | | |
| | | the companies in the | | |
| | | issuer's peer group, grouped | | |
| | | according to the metrics | | |
| | | used in the issuer's LTI | | |
| | | plans. If an issuer does not | | |
| | | use a financial metric in its | | |
| | | LTI plan, it would not be | | |
| | | included in the analysis. | | |
| IPE | IPE-5 | The system will calculate | | 1 |
| | | and display in bar chart | | |
| | | form the three-year TSR for | | |
| | | a user-constructed peer | | |
| | | group, grouped according to | | |
| | | the metrics used in the | | |
| | | issuer's LTI plans. If an | | |
| | | issuer does not use a | | |
| | | financial metric in its LTI | | |
| | | plan, it would not be | | |
| | | included in the analysis. | | |
| IPE | IPE-6 | The system will calculate | | 1 |
| | | and display in bar chart | | |
| | | form the TSR for the | | |
| | | companies in the issuer's | | |
| | | peer group over a time | | |
| | | period selected by the user | | |
| | | (between 1 and 10 years), | | |
| | | grouped according to the | | |
| | | metrics used in the | | |
| | | companies' LTI plans. If an | | |
| | | issuer does not use a | | |
| | | financial metric in its LTI | | |
| | | plan, it would not be | | |
| | | included in the analysis. | | |
| ITS | ITS 1 | Using the issuer's current | | 3 |
| | | financial metrics and peer | | |
| | | group, the system will | | |
| | | display a graph depicting | | |
| | | the distribution of values for | | |
| | | each such metric for the | | |
| | | most recent 10 year period. | | |
| ITS | ITS-2 | Using the financial metrics | | 3 |
| | | selected by the user and the | | |
| | | issuer's current peer group, | | |
| | | the system will display a | | |
| | | graph depicting the | | |
| | | distribution of values for | | |
| | | each such metric for the | | |
| | | most recent 10 year period. | | |
| ITS | ITS-3 | Using the issuer's current | | 3 |
| | | financial metrics and a peer | | |
| | | group selected by the user, | | |
| | | the system will display a | | |
| | | graph depicting the | | |
| | | distribution of values for | | |
| | | each such metric for the | | |
| | | most recent 10 year period. | | |
| ITS | ITS-4 | Using the issuer's current | | 3 |
| | | financial metrics and peer | | |
| | | group, the system will | | |
| | | display a graph depicting | | |
| | | the distribution of values for | | |
| | | each such metric for a time | | |
| | | frame selected by the user | | |
| | | (between 1 and 10 years). | | |
| ITS | ITS-5 | Using the financial metrics | | 3 |
| | | selected by the user and the | | |
| | | issuer's current peer group, | | |
| | | the system will display a | | |
| | | graph depicting the | | |
| | | distribution of values for | | |
| | | each such metric for a time | | |
| | | frame selected by the user | | |
| | | (between 1 and 10 years). | | |
| ITS | ITS-6 | Using the issuer's current | | 3 |
| | | financial metrics and a peer | | |
| | | group selected by the user, | | |
| | | the system will display a | | |
| | | graph depicting the | | |
| | | distribution of values for | | |
| | | each such metric for a time | | |
| | | frame selected by the user | | |
| | | (between 1 and 10 years). | | |
| ITS | ITS-7 | Using the financial metrics | | 3 |
| | | and the peer group selected | | |
| | | by the user, the system will | | |
| | | display a graph depicting | | |
| | | the distribution of values for | | |
| | | each such metric for a time | | |
| | | frame selected by the user | | |
| | | (between 1 and 10 years). | | |
| ITS | ITS-8 | Using the financial metrics | | 3 |
| | | and the peer group selected | | |
| | | by the user, the system will | | |
| | | display a graph depicting | | |
| | | the distribution of values for | | |
| | | each such metric for the | | |
| | | most recent 10 year period. | | |
| ITS | ITS-9 | For all graphics depicting | | 3 |
| | | distribution of financial | | |
| | | metrics, the system will | | |
| | | display the 25^{th}, 50^{th} and | | |
| | | 75^{th} percentile of the data | | |
| | | array. | | |

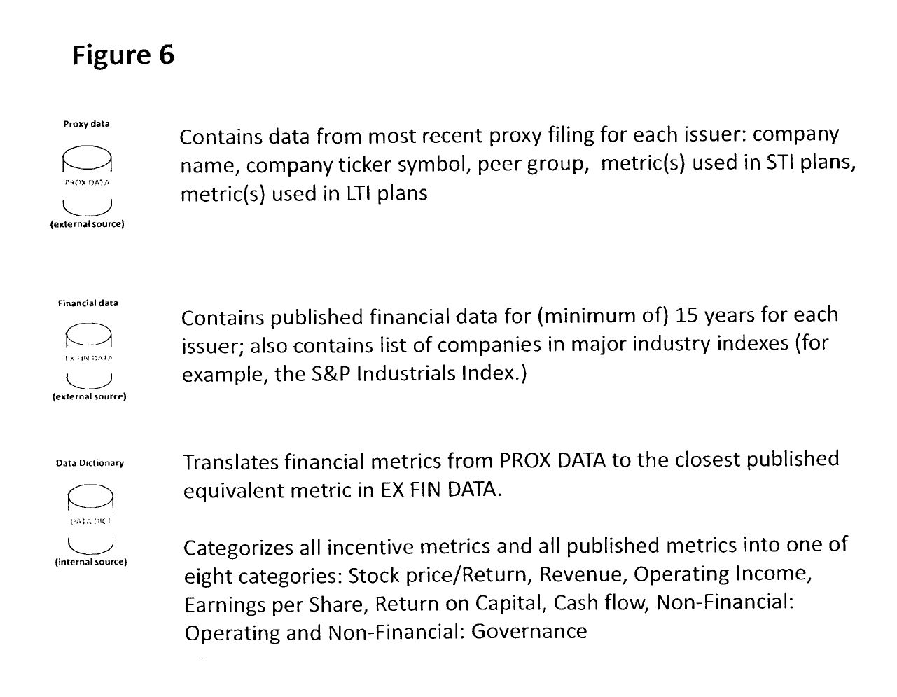

FIG. 6 is a block diagram illustrating the various databases that are used to implement the present invention as shown by the flow charts in FIGS. 1-5.

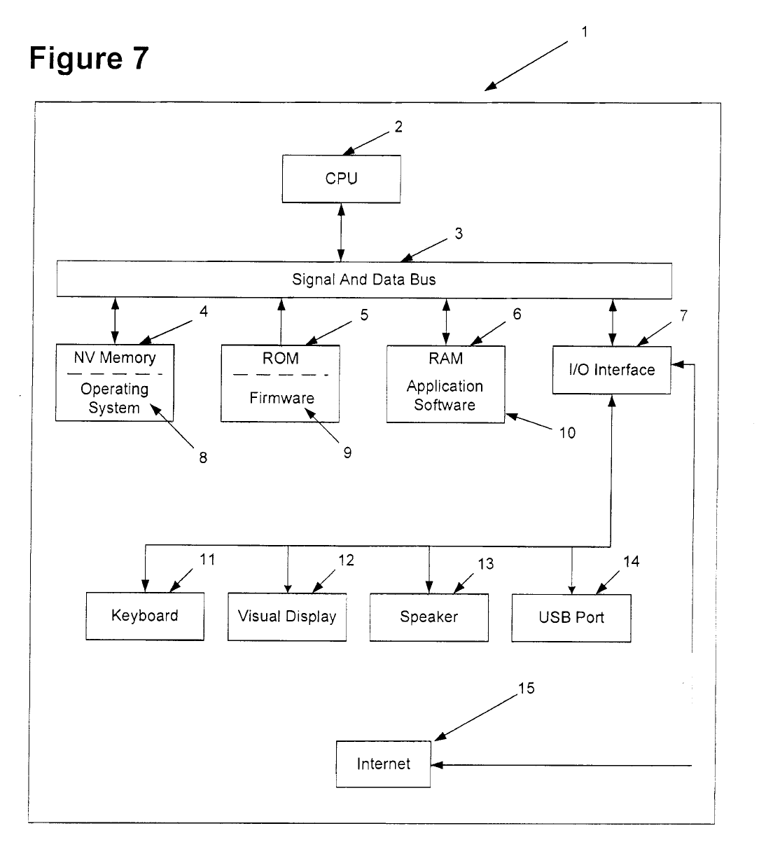

FIG. 7 is a block diagram that illustrates the basic components of a computer system 1 which can be used to implement the exchange in accordance with the present invention.

System 1 includes a CPU 2. The CPU is used for executing computer software instructions as is known in the art. CPU 2 is coupled to a number of other elements via a signal and data bus 3 as is also known in the art. These elements include ROM 5 (Read Only Memory) which may be used to store computer software instructions, RAM 6 (Random Access Memory) which also may be used to store computer software instructions, I/O Interface 7 which may be used to interface CPU 2 to elements and/or functions that are external to controller 1, and Non Volatile Memory 4 which may be used to store computer software instructions as well.

As mention above, I/O Interface 7 is used to interface CPU 2 to external elements. These external elements might include Keyboard 11, Visual Display 12, Speaker 13, USB Port 14 and Internet terminal 15.

Depending on the tasks to be performed by controller 1, its computer software instructions might be divided into two or more separate and distinct categories which are stored in separate portions of ROM 5, RAM 6 and/or Non Volatile Memory 4. In some devices, a basis set of low level operating instructions, known in the art as firmware 9, might be stored in, for example, ROM 5. These low level rudimentary instructions provide the necessary instructions for how the controller communicates with the other computer hardware. Such instructions are necessary for the controller to perform any useful work, regardless of the application for which the device is to be used.

The computer instruction set that is executed by CPU 2 to perform the particular tasks required of the controller is often call “application software” and operationally “sits” on top of firmware 9. As illustrated in FIG. 1, application software 10 is stored in RAM 6. Application software 10 could also be stored in ROM 5 or in Non Volatile Memory 4.

Firmware 9 allows application software 10 to efficiently interface with the other device hardware, such as the elements that are coupled to CPU 2 via I/O Interface 3.

Again, depending on the tasks to be performed by controller 1, a third set of software instructions known in the art as an operating system 8 might operationally “sit” between firmware 9 and application software 10. Operating system 8 is shown as being stored in Non Volatile Memory 4 in FIG. 1 but could be store in RAM 6 as well.

Operating system 8 is the software that is responsible for the management and coordination of activities and the sharing of resources within system 1.

While the foregoing specification teaches the principles of the present invention, with examples provided for the purpose of illustration, it will be appreciated by one skilled in the art from reading this disclosure that various changes in form and detail can be made without departing from the true scope of the invention.

I claim:

1. A system for determining the effectiveness of performance incentives, said system comprising:
a central processing unit;
a display device coupled to said central processing unit for displaying information to a user of said system;
a first memory unit coupled to said central processing unit for storing a computer program for execution by said central processing unit;
a selection module coupled to said central processing unit for allowing a user of said system to select from a plurality of predetermined analytic functions;
a second memory unit coupled to said central processing unit for storing predetermined sets of historic performance analytic data;
an input module coupled to said central processing unit for allowing a user of said system to enter into said system current performance analytic data;
an analysis module coupled to said central processing unit for measuring said current performance analytic data with said historic performance analytic data using a selected one of said predetermined analytic functions and displaying the result on said display screen; and
wherein said computer program is executed by said central processing unit to control said display device, said first and second memory units, said selection module, said input module and said analysis module to implement said system.

2. The system of claim 1, wherein a user can select from a plurality of time frames for said analysis module to measure said current performance analytic data with said historic performance analytic data.

3. The system of claim 1, wherein said information displayed by said display device can be captured for storage and subsequent review.

4. The system of claim 3, wherein said information is captured as a pdf file.

5. The system of claim 3, wherein said information is captured in a spreadsheet file.

6. The system of claim 1, further comprising an authentication module coupled to said central processing unit for authenticating a user into said system, said authentication module being controlled by said central processing unit under said computer program.

7. The system of claim 6, further comprising a computer network access module coupled to said central processing unit for allowing a user of said system to access and be authenticated into said system from a location other than the location of said system, said network access module being controlled by said central processing unit under said computer program.

8. The system of claim 1, wherein said predetermined sets of performance analytic functions are selected from the group consisting of a metric correlation analysis function, an incentive plan effectiveness analysis function and an incentive target setting analysis function.

9. The system of claim 8, wherein said incentive plan effectiveness analysis function comprises an incentive prevalence analysis sub function and an incentive effective ness analysis sub function.

10. The system of claim 1, wherein said historic performance analytic data relates to a current peer of said user.

11. The system of claim 1, wherein said historic performance analytic data relates to other than a current peer of said user.

12. The system of claim 7, wherein said central processing unit, said first memory unit, said selection module and said input module are formed as part of an Internet webserver.

13. The system of claim 12, wherein said selection module controls said webserver to serve a webpage to allow said user to select from a said plurality of predetermined analytic functions.

14. The system of claim 12, wherein said input module controls said webserver to serve a webpage to allow said user to enter into said system current performance analytic data.

15. The system of claim 7, wherein said second memory unit is a database.

16. The system of claim 7, wherein said second memory unit is a database residing on the Internet.
